(19) United States
(12) Patent Application Publication
(10) Pub. No.: US 2002/0154691 A1
(43) Pub. Date: Oct. 24, 2002

(54) System and process for compression, multiplexing, and real-time low-latency playback of networked audio/video bit streams

(76) Inventors: James F. Kost, Westmont, IL (US); Timothy Lottes, Downers Grove, IL (US)

Correspondence Address: PATENTS+TMS, A Professional Corporation, 1914 North Milwaukee Avenue, Chicago, IL, 60647, US

(21) Appl. No.: 09/916,100

(22) Filed: Jul. 26, 2001

Related U.S. Application Data
(60) Provisional application No. 60/285,023, filed on Apr. 19, 2001.

(51) Int. Cl. H04N 7/167; H04B 1/66; H04N 7/12; H04N 11/02; H04N 11/04

(52) U.S. Cl. 375/240.01; 375/240

(57) ABSTRACT

A system and a process for converting analog or digital video presentations such that the presentations remain within a browser as used in Intranet or Internet related applications or the like. A process for modified encoding, proprietary implementation using constant prediction based vectoring to eliminate image error factors resulting in a convergence of quality while eliminating arbitrary positioning to reduce bandwidth transfer rates, multiplexing of variable bit streams, encryption, thread manipulation, plug-in technologies, browser resource utilization, and a unique method of caching, buffering, synchronization, timing, and on-line installation of the plug-in. Further, the present invention may be used in a variety of applications including talking advertising banners, home pages, news reports, greeting cards, sports and entertainment programming, training and education, video conferencing, video E-Mail grams, internet video telephone, webcams, even wireless video telephones. The present invention may develop products including a RIO type player for streaming audio playback and storage, PDA applications, video cell phones, wearable applications, security-cams, interactive video games, interactive sports applications, archiving, VRML video applications, and 360-degree video technologies.

This application claims the benefit of U.S. Provisional Application Serial No.: 60/285,023, filed Apr. 19, 2001.

### BACKGROUND OF THE INVENTION

The present invention generally relates to audio and video compression, transmission, and playback technology. The present invention further relates to a system and process in which the playback occurs within a networked media browser such as an Internet web browser.

Of course, watching video presentations on, for example, the Internet, is well known. Often individuals create videos to share with family and/or friends. Families exchange not only photographs but family videos of weddings, baby's first steps, and other like special moments, with family and friends worldwide. Individuals and businesses often provide video presentations on the Internet as invitations, for purposes of amusing their friends or others and/or to distribute information. For example, news organizations, such as, for example, Fox News and CNN, offer viewing of video presentations over the Internet. Similarly, businesses may showcase their products and services via video presentations. Organizations provide video presentations about their interests, for example, American Memorial Park provides video presentations over the Internet about World War II in the Mariana Islands. Even video presentations of jokes are commonly sent via electronic mail.

Synchronized audio/video presentations that can be delivered unattended over intranets or the Internet are commonly known. However, currently, to view such current media, one is required to use a player that is external to the web browser which must be downloaded and installed prior to viewing. Such external players use overly complex network transportation and synchronization methods which limit the quality of the audio/video and can cause the synchronization or “lip sync” between the audio and video to be noticeably off. Depending on the size of the video presentation, the user often may be required to choose a desired bandwidth to play the video/audio presentation. In many cases, this may cause long delays since large amounts of both audio and/or video data may be extensively encoded and/or encrypted and may even involve other like complicated processes. Often, a significant amount of time, the user may watch the video presentation via the external player. As a result, the video presentation tends to be choppy and often the audio and video are not commonly synchronized.

A need, therefore, exists for providing an improved system such as in a system and process for compression, multiplexing, and real-time low-latency playback of networked audio/video bit streams.

### SUMMARY OF THE INVENTION

The present invention provides high quality scaleable audio/video compression, transmission, and playback technology. The present invention further relates to a system and process in which the playback occurs within a networked media browser such as an Internet web browser.

Further, the present invention provides technology that is extremely versatile. The technology may be scaleable to both low and high bit rates and may be streamed from various networking protocols. The present invention may be used in a variety of applications and products, such as talking advertising banners, web pages, news reports, greeting cards, as well as view E-Mail grams, web cams, security cams, archiving, and internet video telephone. The key elements of the present invention involve a process of encoding/decoding as well as implementation, multiplexing, encryption, thread technology, plug-in technology, utilization of browser technologies, catching, buffering, synchronization and timing, line installation of the plug-in, cross platform capabilities, and bit stream control through the browser itself.

One central advantage of the present invention is how its video compression differs from other methods of video compression. Traditional methods of video compression subdivides the video into sequential blocks of frames, where the number of frames per block generally ranges between 1 to 5. Each block starts with an “Inter-Frame” (often referred to as an “I-Frame”, “Key Frame”, or “Index-Frame”) which is compressed as one would compress a static 2D image. It is compressed only in the spacial dimension. These inter frames limit both the quality and compressibility of a given video stream.

The present invention provides streaming video without using inter frames. Instead, the present invention employs CECP (“Constant Error Converging Prediction”) and works as follows: The compressor works in either a linear or non-linear fashion sending only the differences between the state of decompressed output and the state of the original uncompressed video stream. These differences are referred to as output CED's (“Compression Error Differences”) which are the differences between what is seen on the screen by the viewer and the original video before it is compressed. By using transport protocol of HTTP to send data over the Internet wherein delivery of data is guaranteed, and by eupdating the image with only the “differences” as seen in a sequence with minimal motion, a “convergence of image quality” occurs which acts to reduce the difference between the original video stream and the decompressed video stream. Any area on the screen containing significant differences (or motion) will converge to maximum quality depending on the bandwidth available. This advantage of the present invention manifests itself in its ability to produce extremely high quality video in areas of low-motion, and comparable if not better quality video in areas of high motion, without the use of high-bandwidth inter frames. This has proved to be superior to current streaming video technologies. As a result, there are a number of other products which can be developed with the present invention including: Developing a RIO type player for Streaming Audio playback and storage, Video E-Mail, PDA applications, Video Cell Phone, Internet Video Telephone, Videoconferencing, Wearable applications, Webcams, Security cams, Interactive Video Games, Interactive Sports applications, Archiving, VRML video applications, 360-degree video technologies, to name a few.

Various methods of lossy and loss-less encoding video/audio differenced data can be incorporated into the present invention as long as they have the properties described above. For example, the video CODEC designated H.263 and audio CODEC designated G.729(e) are generally slow and primitive in their implementation and performance but may be modified to work with the present invention.

As a result, the system and process of the present invention may comply with ITU standards and transmission protocols, 3G, CDMA and Bluetooth, as well as others by adhering to the “syntax” of the ITU standard. But because the final encoding, decoding, and playback process of the present invention does not resemble the original CODECs, the final product may have its own “Annex.” The system and process of the present invention complies with the “packet requirements” of the ITU for transmission over land-based or wireless networks, but does not comply with the architecture or technology of the CODECs.

The next key element of the present invention is the way it “multiplexes” two distinctively different and variable bit streams (audio and video) into one stream. The present invention multiplexes by taking a block of data from the video stream and dynamically calculates the amount of data from the audio stream that is needed to fill the same amount of “time” as the decompressed block of video, then repeats this process until it runs out of data from the original video and audio streams. This “time-based” multiplexed stream is then “encrypted” using a method that maximizes the speed vs. security needs of the stream's author, and can easily be transported across a network using any reliable transport mechanism. One such Intranet and Internet transport mechanism primarily used in the present invention is HTTP. In this way, the audio/video bit stream playback remains within the web page itself in the same way one can place an animated .gif image in a web page.

The element of the present invention that “plays” the audio/video bit stream is a simple Internet browser “plug-in” which is quite small in size compared to the external player applications which “play” the audio/bit stream outside of the browser window and can actually be quickly downloaded and installed while a viewer is “on-line” ahead of the audio/video presentation. This special plug-in allows the browser to display the present invention's audio/video stream as naturally as it would display any built-in object such as an image. This also allows the web page itself to become the “skin” or interface around the player. Another side effect of using a web browser to play the audio/video stream is that the bit stream itself can be “conditioned” to allow a person to play the stream once, and after it has been cached, the file can be re-played at a later time without having to re-download the stream from the network, or the file may be “conditioned” to only play once over the web depending on the author's preferences. Moreover, control of the stop and start functions of the player may be controlled with a simple script embedded in the page itself with placement and appearance of the controls left to the preference of the web page author.

The player is used to decipher the incoming multiplexed audio/video stream and subsequently demuxes it into separate audio and video streams which are then sent to the audio and video decompressors. The decompressors generate decompressed audio and video data which the plug-in then uses to create the actual audio/video presentation to be viewed. The plug-in dynamically keeps the video and audio output synchronized for lip-sync. Moreover, if the plug-in runs out of data for either audio or video due to a slow network connection speed or network congestion, it will simply “pause” the presentation until it again has enough data to resume playback. In this way, the audio/video media being presented never becomes choppy or out-of-sync.

To achieve high quality images at narrowband Internet bit rates, the present invention using CECP eliminates “arbitrary positioning,” or the ability to randomly select an image within a bit stream because there are no inter frames within the bit stream on which to select. To overcome this, the present invention can be modified to insert an inter frame every two seconds, or ten seconds, or at any point desired by the author. This versatility is provided to accommodate certain types of applications including playing audio/video presentations from a diskette, cell phone video presentations, PDA videos, and the like.

The system and process of the present invention are based, in part, on the use the YUV-12 or YUV 4:2:0 file format as compared to using RGB or CMYK file types. The system and process of the present invention, therefore, has the capability to encode more information and to limit loss of data which may degrade image quality. The system and process of the present invention may be used to encode YUV 4:2:1 or even YUV 4:2:2 file types to produce higher resolutions and better image quality depending on computer power available.

Further, the system and process of the present invention may utilize a highly modified audio CODEC which plays sounds that may only be heard by the human ear and may mask those frequencies which are not in use. This variable bit CODEC may be changed to a constant bit rate with a sampling rate comparable to 44:1 kHz Stereo, 22.5 kHz Monaural, or other similar rates depending on the quality desired. Bit rates may be varied from 64 Kbps to 40 Kbps, 32 Kbps, 24 Kbps, or the like. The streaming audio may be significantly higher than MP3 at substantially lower bit rates which may usually be encoded at 15 Kbps sampling rate at 128 Kbps.

To this end, in an embodiment of the present invention, a system for conversion of a video presentation to an electronic media format is provided. The system is comprised of a source file having signals, a video capture board having means for receiving signals from the source file and means for interpreting the signals received by the video capture board. The system is further comprised of means for converting the signals received by the video capture board to digital data, means for producing a pre-processed file from the digital data of the video capture board and a means for producing output from the pre-processed file of the video capture board.

In an embodiment, the system for conversion of a video presentation to an electronic media format is further comprised of an input means associated with the video capture board for receiving the signals from the source.

In an embodiment, the system for conversion of a video presentation to an electronic media format is further comprised of a pre-authoring program wherein the pre-authoring program receives the output from the pre-processed file of the video capture board and modifies the output.

In an embodiment, the system for conversion of a video presentation to an electronic media format is further comprised of a disk wherein the output modified by the pre-authoring program is written to the disk such that a user may obtain the modified output.

In an embodiment, the system for conversion of a video presentation to an electronic media format is further comprised of means for encoding the output modified by the pre-authoring program.

In an embodiment, the system for conversion of a video presentation to an electronic media format is further comprised of means for encrypting the output after the output has been encoded.

In an embodiment, the system for conversion of a video presentation to an electronic media format is further comprised of means for multiplexing the output.

In an embodiment, the system for conversion of a video presentation to an electronic media format is further comprised of means for encrypting the output after the output has been multiplexed.

In another embodiment of the present invention, a process for conversion of a video presentation to an electronic media format is provided. The process comprises the steps of providing a source file having signals, providing a video capture board having means for receiving signals from the source file, interpreting the signals received from the source file, converting the signals received from the source file to digital data, producing a pre-processed file from the digital data and producing a finished file output from the pre-processed file.

In an embodiment, the finished file output is an analog video presentation.

In an embodiment, the finished file output is a digital video presentation.

In an embodiment, the process for conversion of a video presentation to an electronic media format further comprises the step of modifying the finished file output such that a video image size is modified.

In an embodiment, the process for conversion of a video presentation to an electronic media format further comprises the step of modifying the finished file output such that a frame rate is modified.

In an embodiment, the process for conversion of a video presentation to an electronic media format further comprises the step of modifying the finished file output such that a re-sampling audio is modified.

In an embodiment, the process for conversion of a video presentation to an electronic media format further comprises the step of providing an input associated with the video capture board wherein the video capture board acquires the signals from the source file.

In an embodiment, the process for conversion of a video presentation to an electronic media format further comprises the step of retrieving the finished file output produced from the pre-processed file wherein the finished file output is in an uncompressed format.

In an embodiment, the process for conversion of a video presentation to an electronic media format further comprises the step of retrieving the finished file output produced from the pre-processed file wherein the finished file output is visual finished file output.

In an embodiment, the process for conversion of a video presentation to an electronic media format further comprises the step of retrieving the finished file output produced from the pre-processed file wherein the finished file output is an audio finished file output.

In an embodiment, the process for conversion of a video presentation to an electronic media format further comprises the step of retrieving the finished file output produced from the pre-processed file wherein the finished file output is a combination of an audio output and a visual output.

In an embodiment, the process for conversion of a video presentation to an electronic media format further comprises the step of creating delays to maintain synchronization between the audio output and the visual output.

In an embodiment, the process for conversion of a video presentation to an electronic media format further comprises the step of correcting for cumulative errors from loss of synchronization of the audio output and the visual output.

In an embodiment, the process for conversion of a video presentation to an electronic media format further comprises the step of encoding the audio output and the visual output.

In an embodiment, the process for conversion of a video presentation to an electronic media format further comprises the step of selecting a desired transfer rate for adjusting encoding levels for the audio output and the visual output.

In an embodiment, the process for conversion of a video presentation to an electronic media format further comprises the step of encoding the finished file output.

In an embodiment, the process for conversion of a video presentation to an electronic media format further comprises the step of encrypting the finished file output after the finished file output has been encoded.

In an embodiment, the process for conversion of a video presentation to an electronic media format further comprises the step of multiplexing the finished file output.

In an embodiment, the process for conversion of a video presentation to an electronic media format further comprises the step of encrypting the finished file output after the finished file output has been multiplexed.

In an embodiment, the process for conversion of a video presentation to an electronic media format further comprises the steps of dividing the finished file output into a pre-determined size of incremental segments and multiplexing the predetermined size of incremental segments into one bit stream.

In an embodiment, the process for conversion of a video presentation to an electronic media format further comprises the step of encrypting the bit stream after multiplexing.

In an embodiment, the bit stream is an alternating pattern of signals.

In an embodiment, the process for conversion of a video presentation to an electronic media format further comprises the step of incorporating intentional delays into the bit stream while encoding the bit stream.

In an embodiment, the process for conversion of a video presentation to an electronic media format further comprises the step of decrypting signals from the finished file output as the signals are received.

In an embodiment, the process for conversion of a video presentation to an electronic media format further comprises the step of creating a rim buffering system for playback of the finished file output.

In an embodiment, a process for encoding a file is provided. The process comprises the steps of providing a file having a first frame and a second frame, processing data from the first frame, reading data from the second frame, skipping data from the second frame that was processed in the first frame and processing data from the second frame that was not skipped.

In an embodiment, the process for encoding a file is further comprised of the steps of extracting vectors from the first frame after the data has been processed and extracting vectors from the second frame after the data has been processed.

In an embodiment, the process for encoding a file is further comprised of the step of quantifying the vectors.

In an embodiment, the process for encoding a file is further comprised of the step of compressing the vectors into a bit stream to create motion.

In an embodiment, an encoding process is provided. The encoding process comprises the steps of processing data and vectors from a first frame, creating an encoded frame from the processed data and vectors of the first frame, processing data and vectors from the second frame, rejecting data and vectors from the second frame that are identical to the data and vectors of the first frame, and adding the processed data and vectors from the second frame to the encoded frame.

In an embodiment, the encoding process further comprises the step of processing data and vectors from subsequent frames.

In an embodiment, the encoding process further comprises the step of rejecting data and vectors from the subsequent frame that are identical to the data and vectors of the first frame and second frame.

In an embodiment, the encoding process further comprises the step of adding the processed data and vectors from the subsequent frames to the encoded frame.

In an embodiment, an encoding process for encoding an audio file is provided. The process comprises the steps of providing an audio sub-band encoding algorithm designed for audio signal processing, splitting the audio file into frequency bands, removing undetectable portions of the audio file and encoding detectable portions of the audio file using bit-rates.

In an embodiment, the encoding process for encoding an audio file is further comprised of the step of using the bit-rates with more bits per sample used in a mid-frequency range.

In an embodiment, the bit-rates are variable.

In an embodiment, the bit-rates are fixed.

In an embodiment, a rim buffering system is provided. The rim buffering system is comprised of means for loading a file, means for presenting the file that has been loaded, a buffer for buffering the file that has been presented, means for automatically pausing the file while being presented when the buffer drops to a certain level and means for restarting the presentation of the file while maintaining synchronization after the buffer reaches another level.

In an embodiment, a process for enabling a bit stream to be indexed on a random access basis is provided. The process for enabling a bit stream to be indexed on a random access basis is comprised of the steps of providing one key frame, inserting the one key frame into a bit stream at least every two seconds, evaluating the one key frame, eliminating the one key frame if the one key frame is not required and updating the bit stream with the one key frame.

In an embodiment, the process for enabling a bit stream to be indexed on a random access basis is further comprised of the step of using a low bit stream transfer rate.

It is, therefore, an advantage of the present invention to provide a system and process for converting analog or digital video presentations such that the video presentation remains within a browser as used in Intranet or Internet related applications or the like.

Another advantage of the present invention is that it may provide synchronized audio/video presentations that may be delivered unattended over Intranets and Internets without having to download the presentation and/or use an external player.

Yet another advantage of the present invention is to provide an encoding technology that processes data from a “first” or “source frame” and then seeks only new data and/or changing vectors of subsequent frames.

Further, it is an advantage of the present invention to provide an encoding process wherein the encoder skips redundant data, thus acting as a “filter” to reduce overall file size and subsequent transfer rates.

Still further, an advantage of the present invention is to provide a process wherein changes in the bit stream are recorded and produced in the image being viewed thereby reducing the necessity of sending actual frames of video.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of conversion of a video presentation to an electronic media format in an embodiment of the present invention.

FIG. 2 illustrates a black box diagram of encoding process in an embodiment of the present invention.

FIG. 3 illustrates a black box diagram of encoding process in another embodiment of the present invention.

### DETAILED DESCRIPTION OF THE PRESENTLY PREFERRED EMBODIMENTS

The present invention provides high quality audio and video technology for the worldwide web which may be used, for example, during video presentation and/or live presentations. Further, the present invention provides technology that is extremely versatile and can be used in a variety of applications such as talking advertising banners, home pages, news reports, greeting cards, as well as Video Conferencing, Video E-Mail grams, Internet Video Telephone, Web Cams, even wireless video telephones. The key elements of the present invention involve a process of encoding including implementation, multiplexing, encryption, multi-thread technology, plug-in technology, browser utilization, catching, buffering, lip sync, timing, and on-line installation.

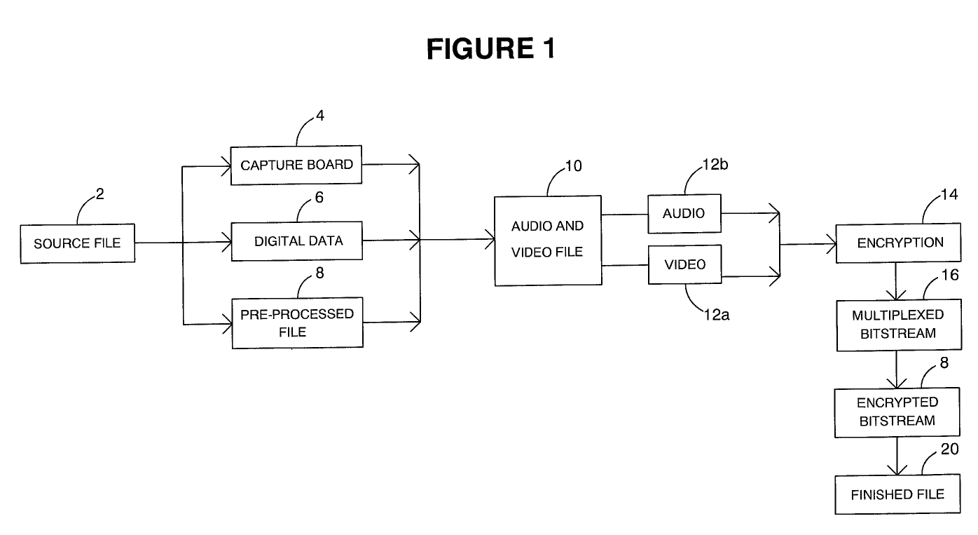

Referring now to the drawings wherein like numerals refer to like parts, FIG. 1 generally illustrates a diagram of components for implementing the conversion of a video presentation to an electronic media format in an embodiment of the present invention. A source file 2, such as an analog video presentation or a digital video presentation, may be converted to a finished file 20 in an electronic media format.

The conversion of the analog video presentation or the digital video presentation may use a video capture board 4, such as, for example, the Osprey 200, Pinnacle's Studio Pro, or Studio Pro PCTV. The capture board 4 may be installed in, for example, a personal computer having a processor. The capture board 4 may be equipped with an S-Video input as well as an RCA audio and/or video inputs and/or a USB Firewire connection which may enable the board to acquire the signals from the source, e.g., a VHS Video player, a DVE deck, a Beta SP deck, or the like.

The signal may be interpreted by the capture board 4 and may be converted into digital data 6 to produce a pre-processed file 8. The pre-processed file 8 may be, for example, a standard NTSC output of thirty frames per second in a window size of 640×480 or 320×240 pixels depending on the capture board 4 that may be implemented. Audio may be output at the sampling rate of 44.1 kHz Stereo. During the above-described process, all data is output in an uncompressed format.

A pre-authoring program such as Adobe Premiere or Media Cleaner Pro, for example, may be used to “grab” the output from the capture board 4 and may re-size the video image size, adjust the frame rate and/or re-sample the audio. The two processed files, audio and video, may then be written as a combined audio-video file 10 to a disk in an uncompressed format. From this point, a user may open, for example, a media application program of the present invention. The media application program may be used to acquire the uncompressed audio-video files 10. Then, a desired transfer rate may be selected, which, in turn, may adjust the encoding levels for both audio and video, window size, frame rate, and/or sampling rate of the audio. The encoding process of the present invention may then be initiated.

During the encoding process of the present invention, after the first audio-video file 10 has been processed, the program may seek any additional data that may be provided in the next frame. If the same data already exists, the encoder may skip the previous data, passing along the instruction that the previous data should remain unchanged. Thus, the encoding process may act like a filter to reduce overall file size and subsequent transfer rates.

By recording changes in the bit stream, the necessity of having frames, as required by other video technologies, may thereby be reduced. New encoded data and their vectors may be extracted from the processed data. These vectors may then be quantified and compressed into a bit stream to create motion within the video.

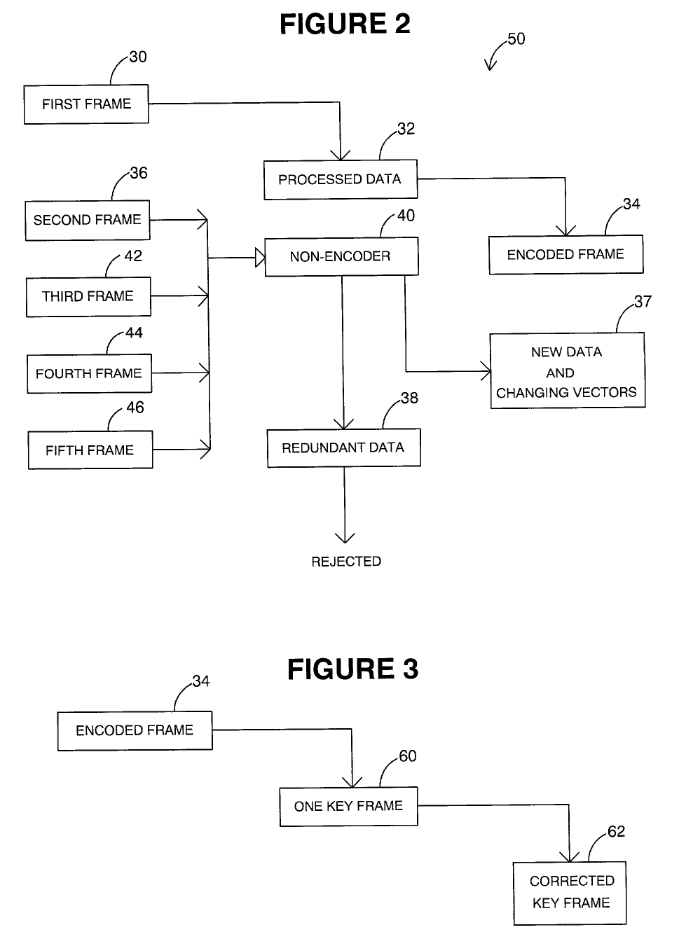

Referring now to FIG. 2, an encoding process 50 of the present invention is generally illustrated. The encoding process 50 may process a first frame 30. Processed data 32 from the first frame 30 may be used to create an encoded frame 34. The encoding process 50 may then process a second frame 36 for new data and changing vectors 37. New data and changing vectors 37 processed from the second frame 36 may be added to the encoded frame 34. Redundant data 38, data that may have already been processed from a previous frame, such as the first frame 30, may be rejected by the non-encoder 40. Subsequent frames such as a third frame 42, a fourth frame 44 and a fifth frame 46 as shown in FIG. 2 may then be processed in the same manner as the second frame 36. New data and changing vectors 37 from the third frame 42, the fourth frame 44 and the fifth frame 46 are added to the encoded frame 34, respectively. Redundant data from any of the previously processed frames is rejected by the non-encoder 40. Any number of frames may be processed in the same manner as the second frame 36 to create the encoded frame 34.

Referring now to FIG. 3, to enable the bit stream to be indexed on a random access basis, one key frame 60 may be inserted into the bit stream every two seconds, for example, for further correction of a key frame 62. If interactivity is not required, the key frame 62 may be eliminated altogether every two seconds. By relying on vectors to update the video and manipulating them using multi-threading technology, the transfer rate may be kept to low levels.

Referring again to FIG. 1, in addition to the video, the audio 12b may be encoded. The audio 12b may be encoded differently than video 12a. Using audio sub-band encoding algorithms designed for audio signal processing, the audio sound may be split into frequency bands, and parts of the signal which may be generally undetectable by the human ear may be removed. For example, a quiet sound masked by a loud sound may be removed. The remaining signal may then be encoded using variable or fixed bit-rates with more bits per sample used in the mid-frequency range. The quality of the audio sound may be directly dependent on the variable or fixed bit rate which controls the bandwidth.

After the audio 12a and the video 12b are encoded (compressed), they may then be encrypted as shown in step 14. After the compressed audio and video are encrypted 14, they may be divided into a pre-determined size of incremental segments and then inter-mixed or multiplexed 16 into one bit stream. For example, the bit stream may be for example, an alternating pattern of signals, such as one audio, one video, one audio, one video, etc. Currently, a streaming video using MPEG-4 keeps bit streams separate which increases the bandwidth required. After the multiplexed bit stream 16 is completed, the bit stream may be encrypted again for additional security. The encrypted bit stream 18 may then be the finished file 20. Although one bit stream may produce each of the segments and may subsequently play them back in a presentation, a significant amount of thread technology is required. Thus, the process and system of the present invention is generally termed “multi-threaded” because of the many different facets of audio and video required to encode and to decode.

Further, to keep audio and video synchronized, intentional delays may be incorporated into the bit stream at the time the program may be encoded or imposed by a plug-in depending on the situation. The length and the frequency of the delays or interruptions may be calculated based on the size of the window involved, frame rate, audio quality, bandwidth availability, type of machine used for playback, and/or other like characteristics.

Since only one frame of video is used with subsequent changes being made to that picture, the process and system of the present invention may be easily streamed over HTTP acting much the same as, for example, a picture downloaded, for example, from a website. Streaming over HTTP may reduce the cost of having high-priced servers perform this task and may minimize any firewall problems often associated with using FTP, UDP, or TCP servers.

To playback the bit stream, a simple browser plug-in or JAVA-based player is required. This allows the browser to accept a foreign file type and utilize its resources. The resources of the browser may be used to distribute and to process the audio and video files for viewing. Other stand-alone applications may have their own resources to accomplish this task or attempt to use JAVA players to perform this operation. By having dual bit streams, however, the results have not been satisfactory.

The plug-in performs several functions. The plug-in may decrypt the files as the files are received and may create a rim buffering system (FIFO) for playback. In addition, since audio generally decodes at a rate faster than video, the plug-in may be used to create certain delays to maintain synchronization between the audio signals and video signals. Because the delays may be mathematically derived, after approximately one to two hours, for example, depending on the presentation and bandwidth involved, a cumulative error may occur causing a loss of synchronization between the audio and video signals. This cumulative error is inherent in the system and process of the present invention. However, the cumulative error may be corrected by zeroing any differential which may exist between the bit stream received and the playback. The synchronization factor changes with the size of the window, frame rate, audio quality, and bandwidth involved thereby requiring a different set of delay requirements. The delay requirements may be determined prior to using the plug-in. After these factors are calculated, no further calculations are generally required to correct for the cumulative error.

Since the audio bit stream decodes faster than the video and usually has priority, the audio bit stream may lead the video slightly. An audio bit stream leading a video bit stream may not be readily recognized by a viewer because after the presentation starts, the audio and video appear to be in synchronization. A discernible facet of a typical presentation is that one may initially hear the audio before the video begins to move. To correct for hearing of the audio prior to the video beginning, a blank frame or a “black frame” may be used to start the presentation as well as functioning as the initial video frame. The blank frame or black frame may be generated by, for example, the plug-in. The initial frame may be used as either a blank frame or title frame to allow the video to begin playing.

A rim buffering system may be used by the system and process of the present invention. The rim buffering system may begin to play after loading 3-6% of the file size or approximately 20-30K, for example, depending on window size, frame rate, audio quality, bandwidth, and/or other like characteristics. The rim buffering system may provide a quicker start for the presentation over other known technologies. Also, the rim buffering system may be designed to automatically pause the presentation if, for example, the buffer drops to a certain level and may restart the presentation after reaching another level while maintaining synchronization. The rim buffering system may be its own clock using the natural playing of the file to maintain lip synchronization. Using the natural playing of the file to maintain lip synchronization may eliminate the clock similarly used in other technologies. To stop the presentation, the user may stop the bit transfer from the server or may close the buffering system allowing the player to run out of data.

As the presentation is played, the bit stream may revert to its original encoded, encrypted state and may remain in cache. After the presentation is played, the user may replay the presentation from cache. However, if the user, for example, leaves a web site page and then returns to attempt to replay the presentation, the presentation may have to be re-transmitted and may not play from cache.

In an embodiment of the present invention, wherein the system and process of the present invention is used over the Internet, a utility may be used to grab frames or files as the frames or files become available from the capture board 4. The capture board 4 realizing the bit stream may be constantly generated from a live feed. For the Internet, the system and process of the present invention may eliminate the need to use, for example, Adobe Premiere to “grab” the audio and video files coming off the capture board 4. Rather, the system and process of the present invention may provide a utility developed to grab the frames or files as they became available from the capture board 4.

As the capture board 4 delivers the video frames in a 640×480 window size at thirty frames per second, the system and process of the present invention may take each frame, analyze the frame for differences previously described, then may re-size the window, may adjust the frame rate and/or provide the vectors that may be required to play the presentation at a lower frame rate, and may encrypt the file in real-time. However, the capture board 4 may usually hold, for example, sixteen seconds of audio in a buffer before the capture board 4 releases the audio to the encoder. Holding the audio in the buffer before releasing the audio may cause a large burst of audio data which generally has to be aligned with the corresponding video data. After releasing the audio, the audio may then be encoded, encrypted and/or divided into segments, multiplexed, encrypted again, and/or delivered to a server in a “multi-pile” stream for distribution either on a broadband or narrowband basis.

Finally, the system and process of the present invention may accommodate multiple users viewing the presentation. Different starting times between users may be accommodated by sending the later user one start frame which may correspond with the incoming vectors for changes. Sending the later user a start frame corresponding with the changing incoming vectors allows other users, after a short period of time, to receive the same vectors from the server. Sending the later user one start frame corresponding with incoming vectors for changes may reduce the load balancing requirements found in most video servers and enable the bit stream to be transmitted from an HTTP server. The bit stream may be transmitted from an HTTP server because the server only sends a copy of the file changes, or vectors, which reduces processing requirements.

The processing requirements of the encoding server of the system and process of the present invention for narrowband versus broadband were compared. For narrowband requirements, a regular mid-range server may be used (450-750 Mhz) with 126 MB RAM. For broadband, a dual processor pentium III may be used due to additional workload. To increase the size of the window, however, the code may be ported to a UNIX based system with four processors, as a result of the increase in the amount of information processed on a real-time basis. In addition, only minimal changes were made to accommodate constant streaming of the presentation during a live broadcast for users at workstations. Accommodating the constant streaming of the presentation during, for example, live broadcast generally involves clearing the cache periodically and re-synchronizing the presentation more often.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A system for conversion of a video presentation to an electronic media format, the system comprising:
a source file having signals;
a video capture board having means for receiving signals from the source file;
means for interpreting the signals received by the video capture board;
means for converting the signals received by the video capture board to digital data;
means for producing a pre-processed file from the digital data of the video capture board; and
means for producing output from the pre-processed file of the video capture board.

2. The system of claim 1 further comprising:
an input means associated with the video capture board for receiving the signals from the source.

3. The system of claim 1 further comprising:
a pre-authoring program wherein the pre-authoring program receives the output from the pre-processed file of the video capture board and modifies the output.

4. The system of claim 3 further comprising:
a disk wherein the output modified by the pre-authoring program is written to the disk such that a user may obtain the modified output.

5. The system of claim 3 further comprising:
means for encoding the output modified by the pre-authoring program.

6. The system of claim 5 further comprising:
means for encrypting the output after the output has been encoded.

7. The system of claim 1 further comprising:
means for multiplexing the output.

8. The system of claim 7 further comprising:
means for encrypting the output after the output has been multiplexed.

9. A process for conversion of a video presentation to an electronic media format, the process comprising the steps of:
providing a source file having signals;
providing a video capture board having means for receiving signals from the source file;
interpreting the signals received from the source file;
converting the signals received from the source file to digital data;
producing a pre-processed file from the digital data; and
producing a finished file output from the pre-processed file.

10. The process of claim 9 wherein the finished file output is an analog video presentation.

11. The process of claim 9 wherein the finished file output is a digital video presentation.

12. The process of claim 9 further comprising the step of:
modifying the finished file output such that a video image size is modified.

13. The process of claim 9 further comprising the step of:
modifying the finished file output such that a frame rate is modified.

14. The process of claim 9 further comprising the step of:
modifying the finished file output such that a re-sampling audio is modified.

15. The process of claim 9 further comprising the step of:
providing an input associated with the video capture board wherein the video capture board acquires the signals from the source file.

16. The process of claim 9 further comprising the step of:
retrieving the finished file output produced from the pre-processed file wherein the finished file output is in an uncompressed format.

17. The process of claim 9 further comprising the step of:
retrieving the finished file output produced from the pre-processed file wherein the finished file output is visual finished file output.

18. The process of claim 9 further comprising the step of:
retrieving the finished file output produced from the pre-processed file wherein the finished file output is an audio finished file output.

19. The process of claim 9 further comprising the step of:
retrieving the finished file output produced from the pre-processed file wherein the finished file output is a combination of an audio output and a visual output.

20. The process of claim 19 further comprising the step of:
creating delays to maintain synchronization between the audio output and the visual output.

21. The process of claim 20 further comprising the step of:
correcting for cumulative errors from loss of synchronization of the audio output and the visual output.

22. The process of claim 19 further comprising the step of:
encoding the audio output and the visual output.

23. The process of claim 22 further comprising:
selecting a desired transfer rate for adjusting encoding levels for the audio output and the visual output.

24. The process of claim 9 further comprising the step of:
encoding the finished file output.

25. The process of claim 24 further comprising the step of:
encrypting the finished file output after the finished file output has been encoded.

26. The process of claim 9 further comprising the step of:
multiplexing the finished file output.

27. The process of claim 26 further comprising the step of:
encrypting the finished file output after the finished file output has been multiplexed.

28. The process of claim 9 further comprising the steps of:
dividing the finished file output into a pre-determined size of incremental segments; and
multiplexing the predetermined size of incremental segments into one bit stream.

29. The process of claim 28 further comprising the step of:
encrypting the bit stream after multiplexing.

30. The process of claim 28 wherein the bit stream is an alternating pattern of signals.

31. The process of claim 28 further comprising the step of:
incorporating intentional delays into the bit stream while encoding the bit stream.

32. The process of claim 9 further comprising the step of:
decrypting signals from the finished file output as the signals are received.

33. The process of claim 9 further comprising the step of:
creating a rim buffering system for playback of the finished file output.

34. A process for encoding a file, the process comprising the steps of:
providing a file having a first frame and a second frame;
processing data from the first frame;
reading data from the second frame;
skipping data from the second frame that was processed in the first frame; and
processing data from the second frame that was not skipped.

35. The process of claim 34 further comprising the steps of:
extracting vectors from the first frame after the data has been processed; and
extracting vectors from the second frame after the data has been processed.

36. The process of claim 35 further comprising the step of:
quantifying the vectors.

37. The process of claim 36 further comprising the step of:
compressing the vectors into a bit stream to create motion.

38. An encoding process, the process comprising the steps of:
processing data and vectors from a first frame;
creating an encoded frame from the processed data and vectors of the first frame;
processing data and vectors from the second frame;
rejecting data and vectors from the second frame that are identical to the data and vectors of the first frame; and
adding the processed data and vectors from the second frame to the encoded frame.

39. The encoding process of claim 38 further comprising the step of:
processing data and vectors from subsequent frames.

40. The encoding process of claim 39 further comprising the step of:
rejecting data and vectors from the subsequent frame that are identical to the data and vectors of the first frame and second frame.

41. The encoding process of claim 39 further comprising the step of:
adding the processed data and vectors from the subsequent frames to the encoded frame.

42. An encoding process for encoding an audio file, the process comprising the steps of:
providing an audio sub-band encoding algorithm designed for audio signal processing;
splitting the audio file into frequency bands;
removing undetectable portions of the audio file; and
encoding detectable portions of the audio file using bit-rates.

43. The process of claim 42 further comprising the step of:
using the bit-rates with more bits per sample used in a mid-frequency range.

44. The process of claim 43 wherein the bit-rates are variable.

45. The process of claim 43 wherein the bit-rates are fixed.

46. A rim buffering system, the system comprising:
means for loading a file;
means for presenting the file that has been loaded;
a buffer for buffering the file that has been presented;
means for automatically pausing the file while being presented when the buffer drops to a certain level; and
means for restarting the presentation of the file while maintaining synchronization after the buffer reaches another level.

47. A process for enabling a bit stream to be indexed on a random access basis, the process comprising the steps of:
providing one key frame;
inserting the one key frame into a bit stream at least every two seconds;
evaluating the one key frame;
eliminating the one key frame if the one key frame is not required; and
updating the bit stream with the one key frame.

48. The process of claim 47 further comprising the step of:
using a low bit stream transfer rate.
